(19) United States
(12) Patent Application Publication
(10) Pub. No.: US 2003/0015556 A1
(43) Pub. Date: Jan. 23, 2003

(54) Closure element for a packing for receiving liquid or paste-like material

(75) Inventors: Hans-Peter Wild, Zug (CH); Eberhard Kraft, Neckarbischofsheim (DE)

Correspondence Address: MARSHALL, GERSTEIN & BORUN, 6300 SEARS TOWER, 233 SOUTH WACKER, CHICAGO, IL, 60606-6357, US

(73) Assignee: Indag Gesellschaft, Fuer Industriebedarf MBH & Co., Betriebs (KG)

(21) Appl. No.: 10/165,234

(22) Filed: Jun. 7, 2002

(30) Foreign Application Priority Data
Jun. 8, 2001 (DE) 101 27 895.0

(51) Int. Cl. A23L 1/00

(52) U.S. Cl. 222/534; 222/107; 222/536; 426/85

(57) ABSTRACT

The present invention relates to a closure element for a packing for receiving liquid or paste-like material, in particular for a film bag. For an easy opening and re-closing of a closure element which requires little space and tightly closes a packing microbiologically also after the filling process, the closure element comprises a tiltable spout with a spout channel and a spout opening which is closed by the spout in a first tilt position and communicates in a second tilt position of the spout with the spout channel thereof, the spout being connected in the area of the spout opening to a membrane which closes the spout opening and is torn open upon a tilting movement of the spout.

The present invention relates to a closure element for a packing for receiving liquid or paste-like material, in particular for a film bag.

Packing containers for receiving liquid or paste-like material, in particular film bags, are used on a large scale, in particular as beverage containers, but also for cosmetics, detergents, etc.

Beverage containers are still mainly opened with the help of drinking straws which are pierced into a piercing portion. This, however, entails the drawback that such beverage containers cannot be closed again, so that the filling material can leak easily and get spoiled rapidly.

It has already been suggested that film bags should be closed with the help of screw caps. Such screw caps, however, entail the drawback that the spouts thereof project from the bag edge to a considerable extent, so that the bags cannot be stacked easily and require a lot of space during transportation. Furthermore, such a closure element entails the drawback that upon loss of the cover the closure element cannot be closed again. A further problem of the known closure elements is, however, that they are in particular not tight microbiologically already after the filling process, i.e. said closure elements are not suited for beverage containers or liquids that have not been preserved, as these may spoil rapidly after having been filled into the film bag.

Although screw caps may already be tight microbiologically, there is always a certain risk that leaky spots which are not noticed in the production process and create problems are formed by small scratches or manufacturing flaws on the members which are to seal one another.

A further drawback is due to the fact that both hands are needed for opening and closing screw caps.

It is therefore the object of the present invention to provide a closure element which can be opened and re-closed easily, which requires little space and which reliably seals the packing microbiologically after the filling process.

According to the invention this object is achieved by a closure element according to claim 1.

Since the closure element can be tilted, it requires less space in comparison with screw caps that require a lot of space. Thanks to the sealing member arranged according to the invention, the closure element can tightly close the filling medium in the packing microbiologically. This leads to a longer storage life and microbiological safety of the filling medium, so that the closure element according to the invention can also be used in a safe way in the food industry. For opening the packing the tiltable spout is then tilted, so that the sealing member that is secured to the spout is torn open. Thus, the liquid can flow to the outside out of the packing through the spout opening and the spout channel of the spout joining the spout opening. In case the packing is to be closed again, this is accomplished by simply tilting the spout into its first tilt position, whereby the spout opening is closed again. Furthermore, the closure element according to the invention entails the advantage that the tiltable spout can be operated with one hand.

When the tiltable spout is substantially tubular, i.e. it has e.g. a round or rectangular cross-section, it is particularly well suited as a drinking straw for beverage containers. Thus, a separate drinking straw need not be provided, which saves costs and material on the one hand and is also advantageous under environmental aspects because less material is needed and used drinking straws and drinking straw packing, respectively, are not just thrown away.

According to a preferred embodiment the sealing member is a membrane. The membrane which closes the spout opening is connected to the spout by gluing or sealing. All standard methods, such as thermal sealing, impulse sealing, etc., are suited as sealing methods; preferably the membrane is sealed or welded by ultrasound. Thus, a firm connection is ensured between membrane and spout and thus a reliable tearing open.

According to a further embodiment of the present invention, the sealing member is a plastic member with a predetermined breaking point.

According to a particular space-saving embodiment, the tiltable spout is positioned in the first tilt position within a recess of the closure element. It can thus be ensured that the closure element projects only very slightly or not at all beyond the bag contour.

For ensuring the original state the recess in which the tiltable spout is located may be closed by a removable film. The consumer can thus see whether a packing is still closed in its original state. Furthermore, such a removable film prevents the spout from getting soiled, for instance during storage, and thus the filling material from being contaminated upon removal. In particular when the spout is used as a drinking straw, the hygienically perfect state of the spout is of decisive importance.

To make sure that the removable film can be removed in an improved way, a trough is located next to the recess for removing the film, the removable film projecting at least in part into the trough region. The consumer can thus grip the film more easily.

The removable film is glued or sealed around the recess in a simple way. To ensure an easy opening, the sealing operation may take place at points or by using peelable sealing media, i.e., media which can be easily separated again. As a result, the film can be removed easily on the one hand and a firm grip is guaranteed on the other hand.

According to a further embodiment the closure element comprises a tubular member which follows the outlet opening at the side opposite the spout. Such an extension of the spout channel entails the advantage that when a film bag is being emptied the front and rear sides of the bag can no longer stick together, which would prevent the liquid from flowing off. As an alternative to a tubular member which extends the spout channel, it is also easily possible to use a spacer which extends from the closure element at the opposite side of the spout.

In an advantageous manner the tiltable spout is rotatably supported about an axis extending in a direction perpendicular to the spout channel.

It is advantageous when the spout opening tightly communicates with the spout channel so that liquid flows out of the packing from the spout opening into the spout channel of the spout and does not run into the recess of the closure element. The end of the spout which faces the spout opening and a portion around the spout opening may comprise a sealing surface which is in rotational symmetry with the tilt axis for the tilting movement between 0° and 90°. This prevents an uncontrolled outflow of liquid.

According to a preferred embodiment the spout has a rounded cross-section at its end facing the outlet opening, said end being fittingly seated around the spout opening. Identity between the cross sections of the spout end and of the area around the outlet opening is of no relevance. The smallest cross-section of the spout substantially defines the maximum flow rate. It may therefore be useful to provide a closure element whose rounded portion around the outlet opening has a maximum cross-section, the cross section of the spout being then adapted in response to product and target group. The round design of the spout end makes it possible that the spout can move easily within the recess. Since the spout has a rounded configuration, in the simplest case it has e.g. a cylindrical surface, the connection between spout channel and spout opening is tightly sealed. In addition, such an arrangement can be produced easily.

Advantageously, the tilt angle between the first and second tilt position is substantially 90°.

According to a preferred embodiment the membrane is an inner film of a film bag. The membrane may e.g. be a polyethylene or polypropylene film or also a coextruded film with an easily sealable outer layer.

Furthermore, the invention relates to a film bag of mono material or composite material with the closure element according to the invention. Advantageously, the closure element according to the invention is sealed or glued between front and rear sides of the film bag on an upper edge or in a corner portion. According to a preferred embodiment the film bag is a beverage bag.

The invention shall now be explained in more detail with reference to the following figures:

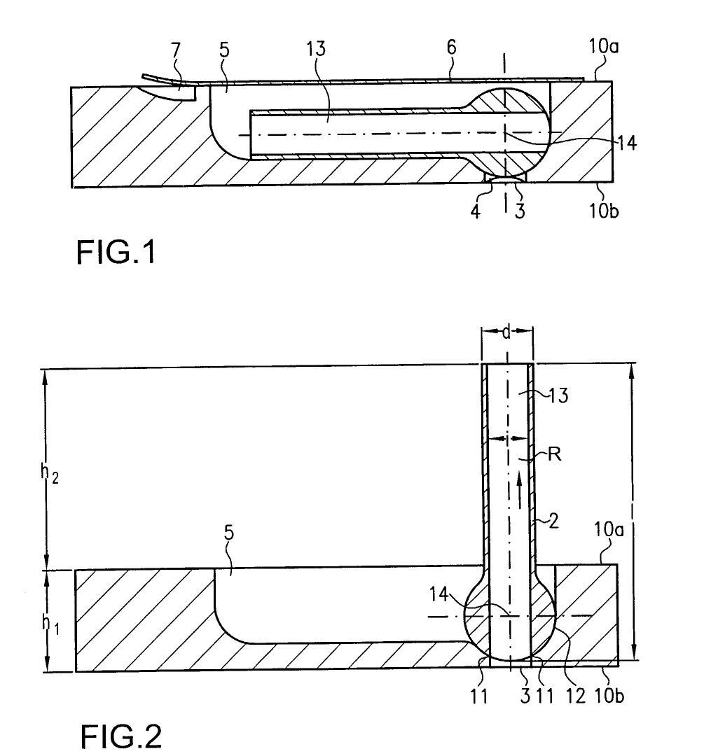

FIG. 1 is a schematic cross-sectional view through a closure element according to the invention in the original closed state;

FIG. 2 is a schematic cross-sectional view of the closure element according to the invention in an opened state;

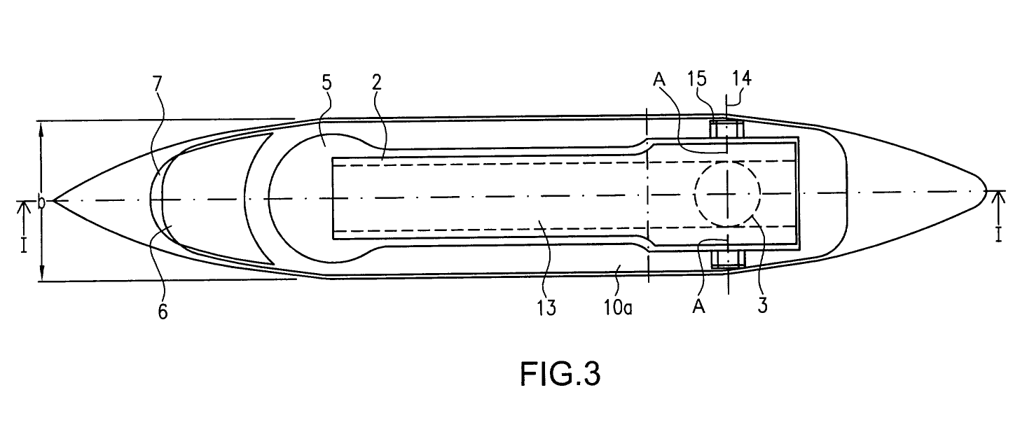

FIG. 3 is a schematic top view on the closure element shown in FIG. 1;

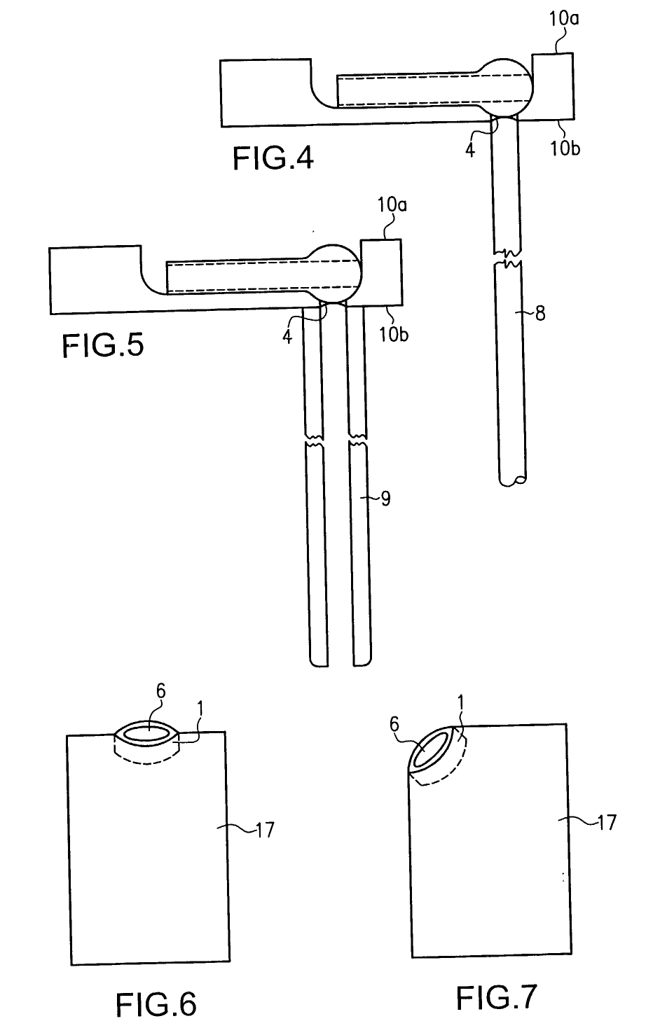

FIG. 4 is a schematic illustration of a further embodiment of the closure element according to the invention with a tubular member;

FIG. 5 shows a further embodiment of the closure element of the invention with spacers;

FIGS. 6 and 7 show film bags with inserted closure elements according to the invention,

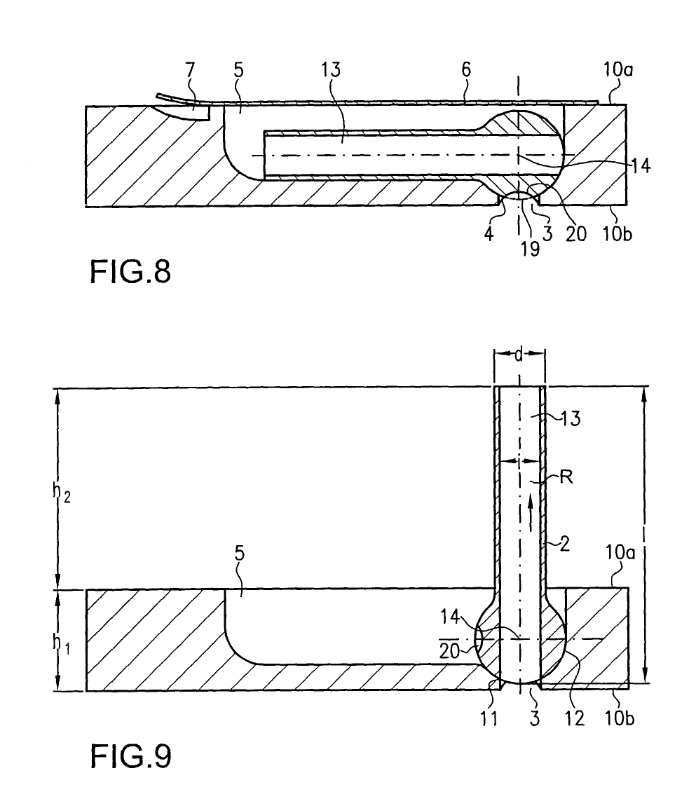

FIG. 8 is a schematic cross-sectional view through a closure element according to the invention in the original closed state according to a further embodiment of the present invention;

FIG. 9 is a schematic cross-sectional view of the closure element according to the further embodiment in the opened state.

As becomes apparent from FIGS. 1 to 3, of which FIG. 1 is a section taken along line I-I of FIG. 3, the closure element 1 of the invention, which is e.g. made from a plastic material, comprises a tiltable spout 2 with a spout channel 13. The tiltable spout 2 is positioned within a recess 5 in the closure element 1 in an original closed state. The spout 2 is rotatably supported about an axis 14 which extends in a direction perpendicular to the spout channel 13 of the spout. The rotatable or tiltable support is shown in the figures only schematically. The rotatable support, however, may also be accomplished in a known way, e.g. by means of a bore provided in the spout 2, through which a shaft extends that, in turn, is fixed by means of fastening members 15.

As an alternative, the spout 2 may also be provided in areas A with two opposite projections that lock into two recesses in the closure element 1 (this embodiment is not shown), so that the spout 2 is rotatably supported about an axis 14. As a further embodiment, which is also not shown, the closure element 1 may comprise two opposite projections which lock into two recesses in spout 2. In this instance, too, the spout 2 is rotatably supported about an axis 14.

The spout 2 has a length l of about 1 to 6 cm. In this embodiment, the upper portion which extends above the surface 10a of the closure element in the unfolded position is tubular. The diameter d of the spout in this portion is 2 to 12 mm, preferably 5 mm. The inner diameter i of the spout channel 13 of the spout 2 is between 2 and 10 mm. The height h₁ of the closure element ranges from 0.5 to 3 cm and is preferably 1 cm. Height h₂ by which the outwardly tilted spout 2 projects from surface 10a of the closure element 1 ranges from 1 to 5 cm and is preferably 2 cm. Width b is between 0.5 and 4 cm, preferably 1 cm.

As becomes clearly apparent from FIGS. 1 and 2, the spout opening 3 which faces the interior of the packing is closed by spout 2 in a first tilt position and is made to communicate with the spout channel 13 of the spout 2 in a second tilt position, so that filling material can flow out of the packing through the spout opening 3 and through the spout channel 13. In this embodiment, as becomes apparent from FIGS. 1 and 2, the spout has a substantially round cross-section in the area of recess 5 at its end 12 facing the outlet opening.

The cross section, however, could e.g. also be substantially rectangular.

Said end 12 is supported in an area of the recess which at least in the area 11 next to the spout opening 3 is made complementary to the rounded end portion 12 of the spout 2. Thus, during its tilting movement the spout 2 can fittingly slide over the surface of the closure element and close said element as shown in FIG. 1. The accurately fitting seat of the spout around the spout opening also ensures that sealing portions 11 are created next to the spout opening 3 for preventing liquid from running out of the packing from the connection portion between spout opening 3 and spout channel 13 into recess 5.

It is here important that the sealing surface of the spout and of the area around the spout opening is in rotational symmetry with axis 14, at least for the tilt movement between 0° and 90°. In the simplest case the spout may have a cylindrical surface which projects beyond the spout opening for sealing purposes. However, other surfaces, such as a spherical surface, or also corrugated toothed surfaces would be suited as long as the movable sealing surfaces sliding on one another project beyond the spout opening.

As becomes apparent from FIG. 1, the spout 2 is positioned within recess 5 in the originally closed closure element 1. The spout 2 is connected in the area of the spout opening 3 to a sealing member, here membrane 4. In this embodiment, the membrane is sealed or welded to spout 2. The membrane 4 is sealed or glued around the spout opening 3, thereby tightly sealing the opening microbiologically. Polyethylene, polypropylene or also a coextruded material having an easily sealable outer layer is e.g. suited as a material for the membrane 4. For instance polyethylene, polypropylene, as well as many modifications based on such raw materials, or also other thermoplastic materials are suited as materials for the spout 2. In the closed state, recess 5 is further closed by a film 6. The film is glued around recess 5 or sealed therearound over the whole surface or at points and serves to ensure the original state and also as a hygienic protection for the spout. Apart from recess 5, a trough 7 is provided over which the film 6 extends at least in part, so that the consumer can remove the film more easily. The following materials are e.g. suited as film 6: mono films or composite films of plastics, foils based on paper or metals, such as aluminum, with a sealable coating of plastics or suited varnishes. Of particular advantage is the use of peelable sealing layers which on the one hand ensure a firm grip of the film and on the other hand permit an easy removal of the film.

When a closure element of an originally packed container is opened, the consumer will first grip the film 6 in the area of trough 7 and remove the same. Thereupon he will tilt the spout 2 about axis 14 by 90° to the outside. A locking or stopping element (not shown) can here limit the maximum deflection of spout 2. During this first tilting movement of the spout 2 the sealing member which is connected to the spout 2, here: membrane 4, is torn open so that the opening 3 is exposed towards the interior of the packing and, in addition, comes into contact with the spout channel 13 of the spout 2. Liquid can now be taken from the packing either by sucking on spout 2—in case the spout serves as a drinking straw, or by pouring the liquid out of the packing or also by drinking as from a bottle or can.

If the packing is to be closed again, this can be accomplished by simply tilting the spout 2 back into recess 5, whereby the end portion of the spout 2 seals the spout opening 3.

FIGS. 8 and 9 show a further embodiment of the present invention. This embodiment is substantially identical with the one shown in FIGS. 1 to 3, but the sealing member 4 is here not a membrane but a plastic member with a predetermined breaking point 19. The sealing member which in this instance closes the spout opening 3, as becomes apparent from FIG. 8, comprises an upwardly “curved portion”. Said “curved portion” projects into a recess 20 of the spout in the downwardly tilted state of the spout 2 and is connected to the spout by gluing, sealing or also by clamping or locking. The curved portion has a predetermined breaking point 19, whereby it can easily be separated from the spout. The “curved portion” is torn off by a first upward tilting of the spout 2, whereby the spout opening 3 is exposed. The broken-off part, however, remains in the recess 20 of the spout 2 because it is connected thereto. Thus, the broken-off part cannot fall into the spout opening and pass into the product or effect a jamming of the tilt mechanism.

FIG. 4 shows a further embodiment where the closure element 1 of the invention, as is e.g. shown in FIGS. 1 to 3 or 8 and 9, further comprises a tubular member 8 at a side 10b of the closure element that is opposite to the spout 2, the tubular member 8 extending into the packing and being an extension of the spout channel 13. The tubular member 8 prevents a situation where e.g. when a film bag is being emptied the front and rear sides of the bag come to rest upon one another during the emptying process, which renders a further emptying operation difficult. The tubular member 8 extends down into a lower portion of the bag.

FIG. 5 shows a further embodiment where, similar to FIG. 4, spacer elements 9 are formed at the side 10b of the closure element 1, the spacer elements being also meant to prevent the front and rear sides of a bag from coming to rest upon one another when a bag is being emptied.

FIGS. 6 and 7 show closure elements 1 of the invention with films 6 which between front and rear side of the film bag 17 are sealed or glued either on an upper edge or in a corner portion of the film bag 17. It is also possible that an inner film of the packing, here of the film bag, is used as a closing membrane for the spout opening 3. The closure element 1 is shaped in the form of a boat, so that the closure element can easily fit between two film sides.

1. A closure element (1) for a packing for receiving liquid or paste-like material, in particular for film bags, comprising:
a tiltable spout (2) including a spout channel (13), and
a spout opening (3) which is closed by said spout (2) in a first tilt position and communicates in a second tilt position of said spout (2) with the spout channel (13) thereof,
said spout (2) being connected in the area of said spout opening (3) to a sealing member (4) which closes said spout opening (3), said sealing member being opened upon a tilting movement of said spout.

2. The closure element (1) according to claim 1, characterized in that said sealing member is a membrane.

3. The closure element (1) according to claim 1, characterized in that said tiltable spout (2) is substantially tubular.

4. The closure element (1) according to claim 2, characterized in that said membrane is sealed or welded to said spout (2), preferably by ultrasonic welding.

5. The closure element according to claim 1, characterized in that said sealing member is a plastic member having a predetermined breaking point.

6. The closure element according to at least one of the preceding claims, characterized in that said tiltable spout (2) is positioned in a recess (5) of said closure element in said first tilt position.

7. The closure element according to at least one of the preceding claims, characterized in that said recess (5) in which said tiltable spout (2) is located is closed by a removable film.

8. The closure element according to at least one of the preceding claims, characterized in that next to said recess (5) a trough (7) is provided in said closure element for removing said film (6), said removable film (6) projecting at least in part into a trough portion.

9. The closure element according to at least one of the preceding claims, characterized in that said removable film is glued around said recess (5) or sealed therearound in a peelable way or at points.

10. The closure element according to at least one of the preceding claims, characterized in that said closure element further comprises a tubular member which follows said outlet opening at the side opposite to said spout (2).

11. The closure element according to at least one of the preceding claims, characterized in that said closure element comprises a spacer (9) at a side opposite to said spout (2).

12. The closure element according to at least one of the preceding claims, characterized in that said tiltable spout (2) is rotatably supported around an axis extending in a direction perpendicular to said spout channel.

13. The closure element according to at least one of the preceding claims, characterized in that said spout opening tightly communicates with said spout channel.

14. The closure element according to claim 12, characterized in that the end (12) of said spout (2) facing said spout opening and an area around said spout opening comprise a sealing surface which is in rotational symmetry with said axis (14) for a tilting movement between 0° and 90°.

15. The closure element according to at least one of the preceding claims, characterized in that said tiltable spout comprises an end (12) facing said outlet opening with a rounded cross-section, said end being fittingly seated on a rounded portion around said outlet opening (3).

16. The closure element according to at least one of the preceding claims, characterized in that said membrane (4) is an inner film of said packing.

17. The closure element according to at least one of the preceding claims, characterized in that said membrane (4) is a polyethylene or polypropylene film or also a coextruded film with an easily sealable outer layer.

18. The closure element according to at least one of the preceding claims, characterized in that said membrane (4) is glued or sealed around said spout opening.

19. A film bag consisting of a mono material or composite material, comprising a closure element according to at least one of claims 1 to 18.

20. The film bag according to claim 19, characterized in that said closure element is sealed or glued between front and rear side of said bag on an upper edge or a corner portion.

21. The film bag according to any one of claims 19 or 20, characterized in that said film bag is a beverage bag.
